(19) United States
(12) Patent Application Publication
(10) Pub. No.: US 2026/0053137 A1
(43) Pub. Date: Feb. 26, 2026

(54) METHOD FOR CONTROLLING PESTS

(71) Applicant: UPL MAURITIUS LIMITED, Port Louis (MU)

(72) Inventors: Katie DRIVER, Knights Landing, CA (US); John AIGNER, Warrenton, VA (US); Cody J. Gray, Durham, NC (US)

(21) Appl. No.: 19/309,063

(22) Filed: Aug. 25, 2025

Related U.S. Application Data
(60) Provisional application No. 63/686,940, filed on Aug. 26, 2024.

(51) Int. Cl. A01N 37/22; A01P 7/04

(52) U.S. Cl. CPC A01N 37/22; A01P 7/04

(57) ABSTRACT

The present disclosure relates to a method for controlling pests. More particularly, the present disclosure relates to a method for controlling pests by application of a benzoylurea insecticide.

### CROSS REFERENCE TO RELATED APPLICATIONS

The present application claims the benefit of U.S. Provisional Application No. 63/686,940 filed on Aug. 26, 2024, which is incorporated by reference in its entirety.

### FIELD OF THE DISCLOSURE

The present disclosure relates to a method for controlling pests. More particularly, the present disclosure relates to a method for controlling pests by application of a benzoylurea insecticide.

### BACKGROUND OF THE DISCLOSURE

Vine mealybug is a serious grapevine pest that can cause significant damage to grapevines. These bugs damage grapevines by sucking juices from the plant, which can lead to stunted growth and decreased crop yield. They are easy to identify because they leave behind white mealy honeydew on leaves and fruit clusters that look like cotton candy. All or most life stages of the vine mealybug can be present year-round on a vine depending on the grape-growing region. In addition, the vine mealybug is much more likely to be found on leaves during the growing season than the other mealybugs. Vine mealybug occurs in all major California production areas.

High reproductive rates and rapid development times promote severe infestations that are difficult to control. Furthermore, vine mealybug's tendency to feed under the bark and below the soil surface offers a refuge from contact insecticides and natural enemies. Damage caused by the vine mealybug is the honeydew that drops onto the bunches and other vine parts and serves as a substrate for black sooty mold. High densities of the pest lead to decreased plant vigour and defoliation; as well as the mealybug itself will be found infesting grape bunches making them unfit for consumption. Ultimately this delays fruit maturity and reduces fruit quality and quantity at harvest. Vine mealybug can also transmit grapevine leafroll-associated viruses.

It can be a challenge to control vine mealybug populations once they reach damaging levels. Successful control of this pest hinges on limiting spread of contaminated plant material complemented by early detection and rapid implementation of chemical and biological control of new infestations. The key to ensuring long-term health of the vines is to use integrated pest management strategies that include monitoring and treatment, as well as prevention. Treatment of grapevine pests can be done using various methods such as pre-planting soil treatments, dormant spray applications, and post-harvest chemical applications.

Conventional control programs for vine mealybug rely on repeated applications of synthetic insecticides throughout the grape-growing season, including organophosphates and neonicotinoids. The efficacy of chemical control is variable and often unsatisfactory, as mealybugs reside primarily in concealed locations (i.e., under the bark and in bark crevices) and on the roots up to 30 cm deep. In vineyards with low mealybug pressure, a single insecticide application in the spring or at bloom is often sufficient for season-long mealybug control. Effective control in heavily infested grape vineyards, planted to a late-harvested variety, may require three or more treatments. Therefore, it is important to consider the timing and frequency of treatment and also which insecticides to apply for the treatment. Basic research aiming at improving the current knowledge on the modes of action of the insecticides should also be extended to enhance their effectiveness as well as their residual action. Additionally, research on cost-effectiveness of use of the insecticides should also receive attention.

### OBJECTIVES OF THE DISCLOSURE

It is a primary objective of the present disclosure to provide a method for controlling or preventing pests in crops.

It is another objective of the present disclosure to provide a method for controlling pests and achieving increased yield in the crops, by reducing the infestation of pests in the crops.

It is yet another objective of the present disclosure to provide a method for controlling pests using a benzoylurea insecticide possessing enhanced efficacy.

It is yet another objective of the present disclosure to provide a method for improving the plant health by application of a benzoylurea insecticide.

It is yet another objective of the present disclosure to provide a method for increasing yield in a plant by application of a benzoylurea insecticide.

It is yet another objective of the present disclosure to provide a method for controlling vine mealybugs, wherein the method comprises applying a benzoylurea insecticide, to a plant or a locus thereof, where the pests occur or are expected to occur.

### SUMMARY OF THE DISCLOSURE

In one aspect, the present disclosure provides a method for controlling pests.

In another aspect, the present disclosure provides a method for controlling vine mealybugs.

In yet another aspect, the present disclosure provides a method for efficient control, suppression, and eradication of vine mealybugs, the method comprising applying an effective amount of a benzoylurea insecticide to a plant or a locus thereof, where the pests occur or are expected to occur.

Additional features and advantages of the present disclosure will be apparent from the detailed description that follows, which illustrates by way of example, the most preferred features of the present disclosure which are not to be construed as limiting the scope of the disclosure described herein.

### DETAILED DESCRIPTION OF THE DISCLOSURE

The present disclosure now will be described hereinafter, in which embodiments of the disclosure are shown. This description is not intended to be a detailed catalogue of all the different ways in which the disclosure may be implemented, or all the features that may be added to the instant disclosure. In addition, numerous variations and additions to the various embodiments suggested herein will be apparent to those skilled in the art in light of the instant disclosure, which do not depart from the instant disclosure. Hence, the following descriptions are intended to illustrate some particular embodiments of the disclosure, and not to exhaustively specify all permutations, combinations and variations thereof.

Unless otherwise defined, all technical and scientific terms used herein have the same meaning as commonly understood by one of ordinary skill in the art to which this disclosure belongs. Although methods and materials similar or equivalent to those described herein can be used in the practice or testing of the disclosure, suitable methods and materials are described herein.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±10 or ±5 of the stated value, percentage or otherwise.

It is to be noted that, as used in the specification, the singular forms “a”, “an”, and “the” include plural referents unless the context clearly dictates otherwise.

The terms “comprising”, “having”, “including”, and “containing” are to be construed as open-ended terms (i.e., meaning “including, but not limited to”) unless otherwise noted. The use of any and all examples, or exemplary language (e.g., “such as”), is intended merely to better illustrate the disclosure and does not pose a limitation on the scope of the disclosure unless otherwise claimed. No language in the specification should be construed as indicating any non-claimed element as essential to the practice of the disclosure as used herein.

The term “vine mealybug” refers to “Planococcus ficus” or “Signoret”, a species of mealybug, belonging to the family Pseudococcidae, native to tropical and subtropical regions. Vine mealybugs are herbivores that feed on all parts of the grapevine plant and weedy plants. The terms can be used interchangeably.

The term “control” or “controlling” insects refers to inhibition of insects, through a toxic effect, the ability of insect pests to survive, grow, feed, and/or reproduce, or to limit insect-related damage or loss in crop plants. To “control” insects may or may not mean killing the insects, although it preferably means reducing insect population by killing the insects. According to the present disclosure, the insect population may be reduced by about 1%, about 4%, about 5%, about 10%, about 15%, about 20%, about 25%, about 35%, about 50%, about 75%, or about 100%, or within any range defined between any pair of the preceding values, such as, from about 1% to about 100%, from about 2% to about 95%, from about 4% to about 95%, or from about 5% to about 75%, upon application of insecticide described herein. In a preferred embodiment described herein, the insect population is preferably reduced by at least 1% upon application of the insecticide. In a more preferred embodiment described herein, the insect population is preferably reduced by at least 5% upon application of the insecticide. In even a more preferred embodiment described, the insect population is preferably reduced by at least 10% upon application of the insecticide.

Subsequently, the term “insecticide” refers to the ability of a substance to decrease or inhibit growth of insects or pests. The term “insects” includes all organisms in the class “Insecta”.

As used herein, the term “insecticidal” refers to the ability of a substance to control or modify the growth of insects or pests. Insecticidal refers to the ability of a substance to increase mortality and/or inhibit the growth rate of insects or pests.

The term “insecticidally effective amount” means the amount of the composition needed to achieve an observable adverse effect on growth, including the effects of necrosis, death, retardation, prevention, and removal, destruction, insect pest mortality, insect pest weight loss, insect pest reduced plant defoliation, and other behavioural and physical changes of an insect pest after feeding and exposure for an appropriate length of time.

The term “locus” of a plant as used herein is intended to embrace the place on which the plants are growing, where the plant propagation materials of the plants are sown or where the plant propagation materials of the plants will be placed into the soil.

The term “crop” shall include a multitude of desired plants or an individual plant growing at a locus. As used herein, the term “plant” and “crop” have been used interchangeably throughout the present disclosure. Said term refers to all physical parts of a plant including foliage/leaves, seeds, seedlings, saplings, roots, tubers, stems, stalks, and fruits.

The term “plant propagation material” is understood to denote generative parts of a plant, such as seeds, vegetative material such as cuttings or tubers, roots, fruits, tubers, bulbs, rhizomes and parts of plants, germinated plants and young plants which are to be transplanted after germination or after emergence from the soil. These young plants may be protected before transplantation by a total or partial treatment by immersion.

The term “pest” refers to an organism, and in particular an insect, which is detrimental to the growth, reproduction, and/or viability of a plant, a portion of the plant or a plant seed. In one aspect, the pest is an insect.

As used herein, the term “increased yield” of an agricultural plant means that the yield of a product of the respective plant is increased by a measurable amount over the yield of the same product of the plant produced under the same conditions, but without the application of the insecticide described herein. According to the present disclosure, the crop yield may be increased by at least 0.5%, at least 1%, at least 2%, at least 5%, at least 10%, at least 15%, at least 25%, at least 50%, at least 75%, or at least 100% or more upon application of the insecticide described herein. In a preferred embodiment, the crop yield is increased by at least 0.5% upon application of the insecticide. In a more preferred embodiment, the crop yield is increased by at least 1% upon application of insecticide. In even a more preferred embodiment, the crop yield is increased by at least 2% upon application of insecticide.

The term “delayed dormant time” or “budbreak” used herein refers to a pesticidal application when a plant, typically a grape vine, is still dormant but about to enter the pre-bloom stage. Dormancy is generally defined as the period from leaf fall until growth resumes in spring. Delayed dormancy is the period from the resumption of growth, indicated by bud swell, until green tip.

The terms “g/L” as used herein denotes the amount of the respective active ingredient in “grams” present in “per litre” of the composition. The terms “g/l” and “g/L” may be used interchangeably. The terms “g a.i./ha” as used herein denotes the concentration of the respective active ingredient in “grams” applied “per hectare” of the crop field. The terms “g ai/ha”, “g a.i./ha” and “g/ha” may be used interchangeably.

Insecticides are classified based on their structure and mode of action. The Insecticide Resistance Action Committee (IRAC) classifies the various insecticides according to their mode of action.

It was found by the inventors of the present invention that an insecticide of the benzoylurea class exhibited enhancement of insecticidal efficacy, reduction in plant disease incidence, and enhanced control of vine mealybugs, with reduced phytotoxicity and improved crop health. Diflubenzuron is a non-systemic insect growth regulator (IGR) that has both contact and stomach action. It's a synthetic benzoylurea insecticide that works by preventing insects from forming chitin, a molecule that's necessary for their outer shell. When insects ingest diflubenzuron, they can't form their protective outer shell and die during molting.

According to an embodiment, the present disclosure provides a method for controlling pests. In another embodiment, the present disclosure provides a method for controlling insecticide-resistant and/or insecticide-tolerant pests.

More particularly, the present disclosure provides a method for controlling pests of Pseudococcidae family. More particularly, the present invention relates to a method for controlling pests of Planococcus genus.

It has been found by the inventors of the present invention that Planococcus genus pests, can be controlled using a benzoylurea insecticide. The degree of enhancement in the efficacy of the above insecticide towards control of Planococcus genus pests, was unpredictable and unexpected.

Moreover, the properties and advantages mentioned are required in practical pest control to keep plants free of diseases, and thus to qualitatively and quantitatively ensure and/or increase the yield in plants.

According to an embodiment, the mode of action of the benzoylurea insecticide is inhibition of chitin biosynthesis affecting CHS1.

In an embodiment, the present disclosure provides a method for controlling pests by application of an effective amount of a benzoylurea insecticide.

In another embodiment, the benzoylurea insecticide is selected from the group comprising diflubenzuron, bistrifluron, chlorbenzuron, chlorfluazuron, dichlorbenzuron, flucycloxuron, flufenoxuron, hexaflumuron, lufenuron, novaluron, noviflumuron, penfluron, teflubenzuron, triflumuron, or combinations thereof.

In a preferred embodiment, the benzoylurea insecticide is diflubenzuron.

As used throughout the disclosure, the benzoylurea insecticide, include their salts, esters, ethers, polymorphs including solvates and hydrates. A salt includes salts that retain the biological effectiveness and properties of the active ingredient, and which are not biologically or otherwise undesirable, and include derivatives of the disclosed compounds in which the parent compound is modified by making inorganic and organic, non-toxic, acid or base addition salts thereof. The salts can be synthesized from the parent compound by conventional chemical methods.

In another embodiment, the present disclosure provides a method for controlling Planococcus genus pests by application of an effective amount of a benzoylurea insecticide.

In a preferred embodiment, the present disclosure provides a method for controlling Planococcus genus pests by application of an effective amount of diflubenzuron.

In another embodiment, the present disclosure provides a method for controlling pests by application of an effective amount of the benzoylurea insecticide to a plant, or a plant propagation material, or a locus thereof. The selection of the effective amount of the insecticide depends on the density of pest infestation, weather patterns, crop health, etc.

In another embodiment, the Planococcus genus pest is selected from the group comprising Planococcus ficus, Planococcus aemulor, Planococcus angkorensis, Planococcus aphelus, Planococcus bagmaticus, Planococcus bendovi, Planococcus boafoensis, Planococcus cajani, Planococcus citri, Planococcus dendrobii, Planococcus dioscoreae, Planococcus dischidiae, Planococcus dubius, Planococcus epulus, Planococcus flagellates, Planococcus fungicola, Planococcus furcisetosus, Planococcus halli, Planococcus hosnyi, Planococcus hospitus, Planococcus indicus, Planococcus japonicus, Planococcus kenyae, Planococcus kraunhiae, Planococcus lilacinus, Planococcus litchi, Planococcus mali, Planococcus martini, Planococcus minor, Planococcus musae, Planococcus nigritulus, Planococcus nilgiricus, Planococcus orchid, Planococcus philippinensis, Planococcus planococcoides, Planococcus principe, Planococcus psidii, Planococcus radicum, Planococcus subterraneus, Planococcus sulawesi, Planococcus taigae, Planococcus tanzaniensis, Planococcus tiomanensis, Planococcus vovae, Planococcus zairensis, or combinations thereof.

In a preferred embodiment, the Planococcus genus pest is Planococcus ficus. In a preferred embodiment, the Planococcus genus pest is vine mealybug.

In a preferred embodiment, the present disclosure provides a method for controlling Planococcus ficus by application of an effective amount of a benzoylurea insecticide. In a preferred embodiment, the present disclosure provides a method for controlling Planococcus ficus by application of an effective amount of diflubenzuron.

In a preferred embodiment, the present disclosure provides a method for controlling vine mealybug by application of an effective amount of a benzoylurea insecticide. In a preferred embodiment, the present disclosure provides a method for controlling vine mealybug by application of an effective amount of diflubenzuron.

According to an embodiment, the present disclosure provides a method for controlling vine mealybug by application of an effective amount of a benzoylurea insecticide, wherein the benzoylurea insecticide is present in an amount ranging from about 10 g/L to about 800 g/L, preferably from about 50 g/L to about 700 g/L, preferably from about 100 g/L to about 600 g/L, preferably from about 200 g/L to about 500 g/L, and most preferably about 480 g/L. In a preferred embodiment, diflubenzuron is present in an amount of about 480 g/L.

According to an embodiment, the present disclosure provides a method for controlling vine mealybug by application of an effective amount of a benzoylurea insecticide, wherein the benzoylurea insecticide is applied at an application rate ranging from about 15 g a.i./ha to about 850 g a.i./ha, preferably from about 100 g a.i./ha to about 700 g a.i./ha, preferably from about 200 g a.i./ha to about 500 g a.i./ha, preferably from about 250 g a.i./ha to about 300 g a.i./ha, and most preferably about 280.34 g a.i./ha. In a preferred embodiment, the benzoylurea insecticide is applied at an application rate of about 280.34 g a.i./ha.

In another embodiment, the present disclosure provides a method for controlling vine mealybug by application of an effective amount of a benzoylurea insecticide at delayed dormant time. The time of application of the benzoylurea insecticide is delayed dormant time. The inventors of the present invention found that with the long residual control of the benzoylurea insecticide, spraying at the delayed dormant time provided enhanced control as crawlers emerge from beneath the bark and start to move up the vine. By controlling the pest at this timing and stage, the crops are healthier.

In a preferred embodiment, the present disclosure provides a method for controlling vine mealybug by application of an effective amount of diflubenzuron at delayed dormant time.

In another embodiment, the method for controlling vine mealybug further comprises at least one additional insecticide.

In another embodiment, the additional insecticide is selected from the group comprising alkyl halide insecticides, aminopyrimidine insecticides, aminotriazene insecticides, antibiotic insecticides, aromatic hydrocarbon insecticides, arylpyrrole insecticides, benzimidazole insecticides, benzoylurea insecticides, beta-ketonitrile insecticides, botanical insecticides, carbamate insecticides, diacylhydrazine insecticides, diamide insecticides, dinitrophenol insecticides, dithiolane insecticides, formamidine insecticides, fumigant insecticides, inorganic insecticides, isoxazoline insecticides, juvenile hormone mimics, juvenile hormones, macrocyclic lactone insecticides, meta-diamide insecticides, methoxyacrylate insecticides, neonicotinoid insecticides, nereistoxin analogue insecticides, organochlorine insecticides, organophosphorus insecticides, oxadiazine insecticides, oxadiazolone insecticides, perfluoroalkyl sulfonamide insecticides, phenol insecticides, precocenes, pyrazole insecticides, pyrethrin insecticides, pyrethroid insecticides, pyridine azomethine insecticides, pyrimidinamine insecticides, pyropene insecticides, RNA1 insecticides, salicylanilide insecticides, semicarbazone insecticides, steroid insecticides, tetramic acid insecticides, tetronic acid insecticides, thiocarbonate insecticides, thiourea insecticides, urea insecticides, unclassified insecticides, or combinations thereof.

In another embodiment, the present disclosure provides a method for controlling vine mealybug by application of an effective amount of an insecticidal combination comprising:
a benzoylurea insecticide; and
at least one additional insecticide.

In another embodiment, the present disclosure provides a method for controlling vine mealybug by application of an effective amount of an insecticidal composition comprising:
a benzoylurea insecticide;
at least one additional insecticide; and
at least one agrochemically acceptable excipient thereof.

According to an embodiment, the insecticidal combination/composition comprising a benzoylurea insecticide and at least one additional insecticide is present either in a form of a tank mix or a pre-formulated (pre-mix) composition.

In an embodiment, the present invention provides a method for controlling vine mealybug by application of an effective amount of a benzoylurea insecticide, wherein the insecticide controls from about 1% to about 100% of the vine mealybug.

In an embodiment, the compositions and methods disclosed herein can be used to control pests in a variety of crop and non-crop applications. In some embodiments, the compositions and methods disclosed herein can be used for controlling pests in crops. Examples of the crops on which the insecticide(s) according to the present disclosure may be used include, but are not limited to, grape vine plant, weedy plants, apples, avocados, banana, date palm, fig, mango, citrus fruits (such as orange, lemon, rime, etc.), oleander, ash tree, walnut, mulberry tree, pomegranate, corn, rice, wheat, barley, rye, oat, sorghum, cotton, soybean, peanut, buckwheat, beet, rapeseed, sunflower, sugar cane, tobacco, etc.; vegetables: solanaceous vegetables such as eggplant, tomato, pimento, pepper, potato, etc., cucurbit vegetables such as cucumber, pumpkin, zucchini, water melon, melon, squash, etc., cruciferous vegetables such as radish, white turnip, horseradish, kohlrabi, Chinese cabbage, cabbage, leaf mustard, broccoli, cauliflower, etc., Asteraceae vegetables such as burdock, crown daisy, artichoke, lettuce, etc, liliaceous vegetables such as green onion, onion, garlic, and asparagus, ammiaceous vegetables such as carrot, parsley, celery, parsnip, etc., chenopodiaceous vegetables such as spinach, Swiss chard, etc., lamiaceous vegetables such as Perilla frutescens, mint, basil, etc, strawberry, sweet potato, Dioscorea japonica, colocasia, etc., flowers, foliage plants, turf grasses, fruits: pome fruits such pear, quince, etc, stone fleshy fruits such as peach, plum, nectarine, Prunus mume, cherry fruit, apricot, prune, etc.; nuts such as chestnuts, hazelnuts, almond, pistachio, cashew nuts, macadamia nuts, etc.; berries such as blueberry, cranberry, blackberry, raspberry, etc., kaki fruit, olive, plum, coffee, coconuts, etc.; trees other than fruit trees; tea, flowering plant, trees such as ash, birch, dogwood, eucalyptus, Ginkgo biloba, lilac, maple, Quercus, poplar, Judas tree, Liquidambar formosana, plane tree, zelkova, Japanese arborvitae, fir wood, hemlock, juniper, Pinus, Picea, and Taxus cuspidate, or combinations thereof. In a preferred embodiment, the crop/plant is grape vine or Vitis vinifera L.

According to an embodiment, the present disclosure provides use of a benzoylurea insecticide for controlling pests. In an embodiment, the present disclosure provides use of a benzoylurea insecticide for improving yield of the desired crop.

In another embodiment, the benzoylurea insecticide of the present disclosure may be applied in combination with agrochemically active components such as fertilizers, macronutrients, micronutrients, biologicals, biostimulants, plant extracts, synergists, or combinations thereof. In an embodiment, the macronutrients or a micronutrient is selected from the group comprising nitrogen, phosphorus, potassium, calcium, sulfur, magnesium, iron, zinc, copper, boron, manganese, chlorine, molybdenum, nickel, or combinations thereof.

According to an embodiment, the benzoylurea insecticide is applied from a hand-held sprayer, pre-dosage device, a knapsack sprayer, a spray tank, a spray plane, or an irrigation system, or a drone, or an spot spray system. Typically, the benzoylurea insecticide is made up with water, buffer, and/or further auxiliaries to the desired application concentration.

In another embodiment, the benzoylurea insecticide may be used for foliar application, application to a ground, or to the soil, or to a plant, or a locus or a plant propagation material, or combinations thereof. In another embodiment, the benzoylurea insecticide can be used in agricultural lands such as fields, paddy fields, lawns and orchards or in non-agricultural lands, fallow fields, or for the purpose of chemical fallow application.

In another embodiment, the disclosure also provides a kit comprising the benzoylurea insecticide for controlling pests or for improving yield of desired crop and instructions for use. The instructions for use typically comprise instructions for the application of the insecticide to a plant, or a locus, or a plant propagation material thereof.

According to an embodiment, the kit of parts comprises:
(a) a benzoylurea insecticide;
(b) optionally an additional insecticide;
and optionally further comprises:
(c) instructions for use.

In view of the above, it will be seen that the several advantages of the disclosure are achieved, and other advantageous results attained. Although the present disclosure has been disclosed in full, it will be understood that numerous additional modifications and variations could be made thereto without departing from the scope of the disclosure.

The disclosure may be embodied in other specific forms without departing from the spirit or essential characteristics thereof. The present embodiments are therefore, to be considered in all respects as illustrative and not restrictive.

### EXAMPLES

### Example 1: Control of Vine Mealybug Using Diflubenzuron

Experiment was conducted to assess the control of vine mealybug using diflubenzuron in grapes.
Soil condition: 6.98 pH with 0.83% organic matter;
Application method: Foliar with a hand-held sprayer;
Spray volume: 150 GPA;
Application time: delayed dormant time/budbreak;

The study was conducted against a very high vine mealybug population and the difference in the mean number of vine mealybug feeding sites after the treatments were observed. Furthermore, the % control of vine mealybug feeding sites after the treatments was also recorded. The results are recorded in Table 1.

TABLE 1

| | | | | Average | % Control |
|---|---|---|---|---|---|
| | | | | Number | of Vine |
| | | | | of Vine | Mealybug |
| Sr. | | Application | | Mealybug | Feeding |
| No. | Treatment(s) | rate | | Feeding Sites | Sites |
| 1 | Untreated | — | | 7.4 | — |
| 2 | Diflubenzuron | 280.34 | g a.i./ha | 0.3 | 95.9 |
| 3 | Buprofezin | 1177.45 | g a.i./ha | 1.3 | 82.4 |
| 4 | Imidacloprid | 560.7 | g a.i./ha | 2.6 | 64.8 |

Therefore, the delay dormant time/budbreak treatment of diflubenzuron resulted in lower mean number of vine mealybug feeding sites compared to the insecticides already being used for control of vine mealybugs, i.e., buprofezin and imidacloprid. In addition, the delay dormant time/budbreak treatment of diflubenzuron resulted in higher % control of vine mealybug feeding sites compared to the insecticides already being used for control of vine mealybugs, i.e., buprofezin and imidacloprid

We claim:

1. A method for controlling a Planococcus genus pest, the method comprising treating the Planococcus genus pest by applying an effective amount of a benzoylurea insecticide.

2. The method as claimed in claim 1, wherein the benzoylurea insecticide is selected from the group consisting of diflubenzuron, bistrifluron, chlorbenzuron, chlorfluazuron, dichlorbenzuron, flucycloxuron, flufenoxuron, hexaflumuron, lufenuron, novaluron, noviflumuron, penfluron, teflubenzuron, triflumuron, and combinations thereof.

3. The method as claimed in claim 1, wherein the benzoylurea insecticide is diflubenzuron.

4. The method as claimed in claim 1, wherein the benzoylurea insecticide is present in an amount ranging from about 200 g/L to about 500 g/L.

5. The method as claimed in claim 1, wherein applying the benzoylurea insecticide is at a rate from about 150 g a.i./ha to about 300 g a.i./ha.

6. The method as claimed in claim 1, wherein the Planococcus genus pest is Planococcus ficus.

7. The method as claimed in claim 1, wherein applying the benzoylurea insecticide is at a delayed dormant time.

8. The method as claimed in claim 1, wherein the method further comprises an additional insecticide.

9. A method for controlling a Planococcus ficus, the method comprising treating the Planococcus ficus pest by applying an effective amount of diflubenzuron.

10. A method for controlling a Planococcus genus pest, the method comprising treating the Planococcus genus pest by applying an effective amount of an insecticidal combination comprising:
a benzoylurea insecticide; and
at least one additional insecticide.

11. A method for controlling a Planococcus genus pest, the method comprising treating the Planococcus genus pest by application of an effective amount of an insecticidal composition comprising:
a benzoylurea insecticide;
at least one additional insecticide; and
at least one agrochemically acceptable excipient.
